(19) United States
(12) Patent Application Publication
(10) Pub. No.: US 2026/0289299 A1
(43) Pub. Date: Sep. 24, 2026

(54) METHOD FOR TRAINING A NEURAL NETWORK TO CONTROL A TECHNICAL SYSTEM

(71) Applicant: Robert Bosch GmbH, Stuttgart (DE)

(72) Inventors: Elias Milios, Stuttgart (DE); Kim Peter Wabersich, Schwaebisch Gmuend (DE); Konrad Groh, Stuttgart (DE); Matthias Woehrle, Bietigheim-Bissingen (DE); Felix Gruber, Muenchen (DE); Felix Berkel, Schifferstadt (DE)

(21) Appl. No.: 19/554,256

(22) Filed: Mar. 2, 2026

(30) Foreign Application Priority Data
Mar. 4, 2025 (DE) 10 2025 108 178.6

(51) Int. Cl. G06N 3/08; G05B 13/02; G05B 13/04

(52) U.S. Cl. CPC G06N 3/08; G05B 13/027; G05B 13/048

(57) ABSTRACT

A method for training a neural network to control a technical system. The method includes ascertaining a partitioning of a control function operating on an input space into a set of first affine functions, each operating on a particular first subset of the input space; training the neural network to approximate the control function in a plurality of iterations, comprising, for each iteration: ascertaining, for each first subset, how the neural network partitions the first subset into second subsets such that it behaves like a particular second affine function on each second subset; ascertaining, for each of the second subsets, an approximation error between the neural network and the control function; ascertaining an overall approximation error between the neural network and the control function from the ascertained approximation errors; and adapting the neural network to reduce the overall approximation error.

### FIELD

The present disclosure relates to methods for training a neural network to control a technical system.

### BACKGROUND INFORMATION

Model predictive control (MPC) makes it possible to control a technical system for which safety guarantees can be given. However, for reasons of efficiency and easier implementation, it may be desirable to approximate and control a model predictive controller by means of a neural network.

Approaches for such an approximation are desirable that make it possible to ensure the safety of the control even when it is carried out by the neural network.

The reference Kvasnica, Michal, et al. “Multi-parametric toolbox (MPT),” ETH—Swiss Federal Institute of Technology, Zurich, Mar. 29, 2006, hereinafter referred to as reference [1], describes a toolbox with algorithms for implementing controllers.

The reference Drammis, Sabrina, et al. “Parallel Algorithms for Exact Enumeration of Deep Neural Network Activation Regions.”, arXiv preprint arXiv:2403.00860, 2024, hereinafter referred to as reference [2], describes an algorithm for ascertaining the partitioning of an input space of a neural network, as performed by the neural network to compute the function represented thereby.

### SUMMARY

According to various example embodiments, a method for training a neural network to control a technical system is provided, comprising:
ascertaining a partitioning of a control function operating on an input space into a set of first affine functions, each operating on a particular first subset of the input space;
training the neural network to approximate the control function in a plurality of iterations, comprising, for each iteration:
   ascertaining, for each first subset, how the neural network partitions the first subset into second subsets such that it behaves like a particular second affine function on each second subset;
   ascertaining, for each of the second subsets, an approximation error between the neural network and the control function;
   ascertaining an overall approximation error between the neural network and the control function from the ascertained approximation errors; and
   adapting the neural network to reduce the overall approximation error.

The method described above allows exact ascertainment and limitation of the overall approximation error. Accordingly, it can be ensured that a level of safety achieved by the control function can also be achieved during control by the neural network.

Various exemplary embodiments are specified below.

Exemplary embodiment 1 is a method for training a neural network to control a technical system, as described above.

Exemplary embodiment 2 is the method according to exemplary embodiment 1, wherein the approximation error for each second subset is ascertained from the difference between the parameters (i.e., the slope parameter, i.e., the linear part by which the input vector from the input space is multiplied (denoted below by F), and the offset parameter, i.e., the additive part, i.e., the vector that is added (denoted below by G)) of the second affine function according to which the neural network behaves on the second subset and the first affine function that operates on the first subset to which the second subset belongs.

This allows for efficient backpropagation during training (see equation (11)).

Exemplary embodiment 3 is the method according to exemplary embodiment 1 or 2, wherein the second subsets are polytopes and the approximation error for each second subset is ascertained from the approximation errors between the neural network and the control function at the vertices of the particular polytope.

This allows exact ascertainment of the approximation errors with low computational effort (see also equation (13), where, instead of the sum over the vertex index l, for example the maximum over the vertices of a particular polytope (i.e., over index l for fixed j, i) can also be used).

Exemplary embodiment 4 is the method according to one of exemplary embodiments 1 to 3, wherein the control function is a control function according to model predictive control (MPC).

The approximation of an MPC using a neural network allows control with lower implementation and computational effort, and thus, for example, real-time control on hardware (e.g. embedded systems) with relatively low computing resources.

Exemplary embodiment 5 is the method according to one of exemplary embodiments 1 to 4, wherein the neural network is trained (i.e., such a number of iterations are performed) until the overall approximation error is within a predetermined range.

As a result, safety guarantees can be provided for control by means of the neural network, because the overall approximation error can be determined or estimated with high accuracy.

Exemplary embodiment 6 is the method according to one of exemplary embodiments 1 to 5, wherein the neural network is trained (i.e., such a number of iterations are performed) until the overall approximation error is contained in a disturbance set of the model predictive control (denoted below by [symbol] _{NN}).

This ensures that control by means of the neural network is just as safe as control by means of the original control function, i.e., the same safety guarantees apply.

Exemplary embodiment 7 is a method for controlling a technical system, comprising training a neural network according to one of exemplary embodiments 1 to 6 and controlling the technical system by means of the neural network (by supplying elements from the input space to the neural network and controlling the technical system according to outputs that the neural network outputs in response to the supply of elements from the input space).

Exemplary embodiment 8 is a data processing system (in particular a control device), configured to perform a method according to one of exemplary embodiments 1 to 7.

Exemplary embodiment 9 is a computer program comprising commands that, when executed by a processor, cause the processor to perform a method according to one of exemplary embodiments 1 to 7.

Exemplary embodiment 10 is a computer-readable medium that stores commands that, when executed by a processor, cause the processor to perform a method according to one of exemplary embodiments 1 to 7.

In the figures, similar reference signs generally refer to the same parts throughout the various views. The figures are not necessarily true to scale, with emphasis instead generally being placed on the representation of the principles of the present disclosure. In the following description, various aspects are described with reference to the figures.

### BRIEF DESCRIPTION OF THE DRAWINGS

FIG. 1 shows a vehicle.

FIG. 2 illustrates the approximation of a model predictive controller (MPC) by a neural network.

FIG. 3 illustrates the segmentation of a two-dimensional input space by an MPC and the control function implemented thereby.

FIG. 4 is a flowchart illustrating a method for training a neural network to control a technical system according to one example embodiment.

### DETAILED DESCRIPTION OF EXAMPLE EMBODIMENTS

The following detailed description relates to the figures, which show, by way of explanation, specific details and aspects of this disclosure in which the subject matter can be executed. Other aspects may be used, and structural, logical, and electrical changes may be carried out without departing from the scope of protection of the present disclosure. The various aspects of this disclosure are not necessarily mutually exclusive, since some aspects of this disclosure may be combined with one or more other aspects of this disclosure to form new aspects.

Various examples are described in more detail below.

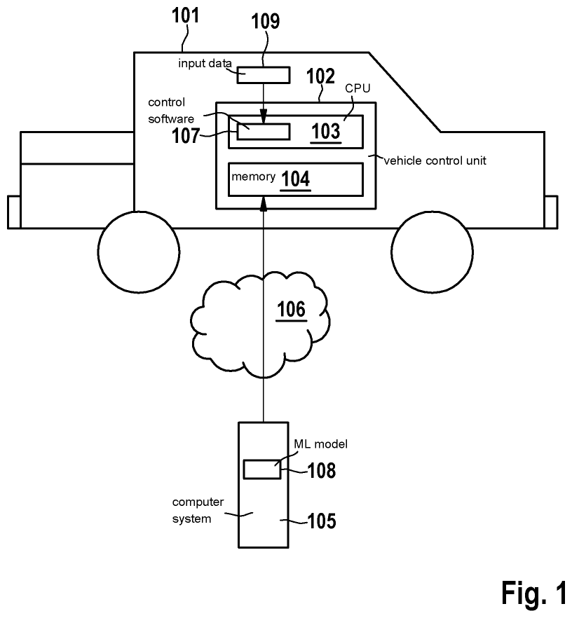

FIG. 1 shows a vehicle 101.

In the example of FIG. 1, a vehicle 101, for example a motor vehicle such as a passenger car or truck, is provided with a vehicle control unit (for example, an electronic control unit (ECU)) 102.

The vehicle control unit 102 comprises data processing components, for example a processor (for example, a CPU (central processing unit)) 103 and a memory 104 for storing control software 107 according to which the vehicle control unit 102 operates, and data that are processed by the processor 103. The processor 103 executes the control software 107 (it is therefore shown in FIG. 1 as part of the processor 103).

For example, the stored control software (computer program) comprises instructions that, when executed by the processor, cause the processor 103 to execute driver assistance functions or even to control the vehicle autonomously. The vehicle 101 is therefore, for example, at least partially automated. The control software 107 carries out one or more driving functions (e.g. fully autonomous driving) by ascertaining control actions for the vehicle (such as steering actions, braking actions, etc.) from input data 109 that are available to it and that contain information about the environment or from which it derives information about the environment, i.e., detects the traffic situation (such as by detecting other road users, e.g. other vehicles), and controlling components of the vehicle accordingly. The input data 109 are, for example, sensor data such as information obtained from a camera of the vehicle or via communication with other vehicles or external apparatuses on the roadside.

The control software 107 is, for example, transmitted to the vehicle 101 from a computer system 105, for example via a network 106 (or by means of a storage medium such as a memory card). This can also take place in operation (or at least when the vehicle 101 is with the user) since the control software 107 is updated over time to new versions, for example.

The control software 107 can, for example, implement a model predictive controller (MPC). In model predictive control, optimal control commands are typically calculated in real time (as far as possible) based on a mathematical model of the vehicle, current state data and predicted future states. This allows for precise and efficient control of the vehicle, in particular in dynamic driving situations. For example, the control software 107 also implements a planning module that plans a trajectory for the vehicle based on an observation of the environment of the vehicle and instructs the MPC to follow this trajectory (e.g. by supplying desired steering angles).

The control software 107 can, for example, be trained by means of machine learning (ML) to approximate an MPC, i.e., the control software 107 implements an ML model 108 (or machine learning model) that is trained on the basis of training data, in this example by the computer system 105. The computer system 105 therefore implements an ML training algorithm for training an ML model 108 that serves to implement an MPC.

Approximating an MPC by means of an ML model, e.g. a neural network, instead of an exact implementation of the MPC allows for more efficient control, as it makes it possible to implement a simpler control function (i.e., the neural network is less complex than an exact implementation of the MPC). Furthermore, efficient hardware is typically readily available for the implementation of neural networks.

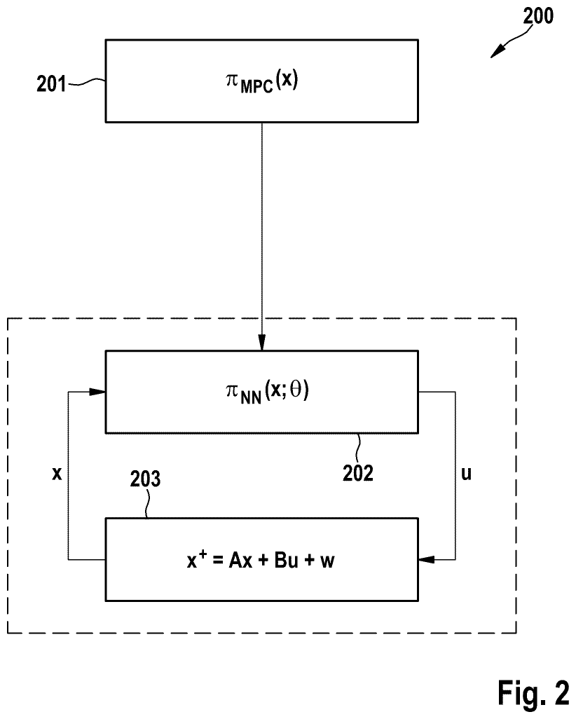

FIG. 2 illustrates the approximation of a model predictive controller (MPC) 201, represented by the function π_{MPC}(x) implemented thereby, using a neural network (NN) 202, represented by the function π_{NN}(x; θ) implemented thereby with parameters (in particular weights) θ. The model predictive controller 201 is designed to be robust against additive input disturbances, i.e., it is designed to ensure conditions with respect to stability, state, and input data for a controlled system 203 that behaves according to an equation of the form

$$x ( k + 1 ) = Ax ( k ) + B ( u ( k ) + {w}_{NN} ( k ) ) + Ew ( k ) . \qquad ( 1 )$$

Here, the conditions are given by conditions on the membership of the respective quantities in certain sets: state conditions x(k)∈ [symbol] ⊂ [symbol] ⁿ^{ₓ}, input conditions u(k)∈ [symbol] ⊂ [symbol] ⁿ^{ᵤ}, actual system disturbances w_{NN}(k)∈ [symbol] _{NN}⊆ [symbol] ⁿ^{ᵤ} and additive input disturbances w_{NN}(k)∈ [symbol] _{NN}⊆ [symbol] ⁿ^{ᵤ} with a user-defined disturbance set [symbol] _{NN} (or disturbance range) containing the origin.

The user-defined disturbance set [symbol] _{NN} defines the maximum approximation error of the model predictive controller 201 by the neural network 202 in advance, i.e., before the training of the neural network 202, and can be considered a hyperparameter of the training method. This means that the application of control u(k)=π_{NN}(x(k);θ) to the controlled system 203 can be considered an application of u(k)=π_{MPC}(x(k)+w_{NN}(k).

For the example of controlling a vehicle, the states, inputs (i.e., input data), and disturbances are given, for example, as follows:

$$x = ( \begin{matrix}{y}_{e} \\ {Ψ}_{e} \\ {\dot{Ψ}}_{e} \\ β \\ δ\end{matrix} ) , u = {δ}_{d e s} , w = {\ddot{Ψ}}_{w} , \qquad ( 2 )$$

with the following states: lateral error with respect to the center line yₑ, yaw angle error relative to the angle of the (road) center line Ψ(e), yaw angle error rate \dot{Ψ}ₑ, wheel slip angle β and steering angle δ. The control input δ_{des} defines the desired steering angle that is sent to the vehicle steering system. The disturbance variable \ddot{Ψ}_{w} comprises unmodeled external effects such as road gradient, crosswinds, etc. The corresponding linearized dynamics A, B, E can be derived from (conventional) vehicle models. The corresponding conditions for states and inputs are given, for example, by box constraints of the following form:

$$𝒳 = \{ x ∈ {ℝ}^{{n}_{x}} \vert - \overline{x} \leq x \leq \overline{x} \} 𝒰 = \{ u ∈ {ℝ}^{{n}_{u}} \vert - \overline{u} \leq u \leq \overline{u} \} \\ 𝒲 = \{ w ∈ {ℝ}^{{n}_{w}} \vert - \overline{w} \leq w \leq \overline{w} \} \qquad ( 3 )$$

with constant limits, which are given, for example, by x̅=[1, π/2, π/2, π/20, π/10]^{τ}, ū=π/10 and w̅=[π/20] on the basis of safety requirements and physical information of the system. The selection of

$${𝒲}_{NN} = \{ w / - 0.01 \leq w \leq 0. 01 \}$$

would, for example, specify a maximum approximation error of 0.01. In motion control, the goal is usually to remain comfortably close to the center line, which can be described by a positively defined cost function

$$ℓ ( x , u ) = {x}^{T} Q x + {u}^{T} R u \qquad ( 4 )$$

by selecting, e.g., Q=diag(1, 10, 10, 1, 1) R=1.

Therefore, a neural network π_{NN}: [symbol] ⁿ^{ₓ}→ [symbol] ⁿ^{ᵤ} can be used to approximate the control function represented by a model predictive controller, i.e., so that π_{NN}(x;θ)≈π_{MPC}(x), where θ are the parameters (weights) of the neural network. The neural network can be trained using a randomly generated dataset

$$𝒟 = \{ ( {x}^{( j )} , {π}_{MPC} ( {x}^{( j )} ) ) \} \qquad ( 5 )$$

of state-input pairs, wherein the neural network can be trained to minimize the approximation error π_{NN}(x^{(j)};θ)−π_{MPC}(x^{(j)}) on the basis of a standard regression loss function.

After training, the control of the particular controlled system 103 (i.e., for example, the closed-loop control of a vehicle 101 to follow a planned trajectory) can be verified by means of Monte Carlo simulations over a finite time horizon t_{f}<∞ on the basis of randomly selected initial states x(0)~p(x₀) and disturbances w(k)~p(w) to ensure that the neural network 202 approximates the MPC (or the control function implemented thereby) sufficiently well along possible state sequences of the closed-loop control (in order to be able to ensure safety and stability when using the neural network instead of the MPC). A certain number of successful Monte Carlo simulations implies safety and stability at a corresponding probability level, i.e., with a certain probability.

However, if verification by means of Monte Carlo simulation fails (e.g. if a sequence of states is found for which the neural network does not approximate the MPC sufficiently well), additional data must be generated and the neural network must be retrained to reduce the approximation error. There is also no guarantee that the verification step after retraining will provide a higher probability that the approximation is good enough to ensure safety and stability. A robust guarantee (probability of 1 that the approximation is good enough) cannot be given: only probabilistic guarantees are given for a finite time horizon t_{f}<∞ and with respect to a certain initial state distribution p(x₀) and disturbance distribution p(w).

In light of the above, according to various embodiments, a neural network (using ReLU (rectified linear unit) as activation functions) is trained to approximate an MPC in a way that allows the approximation error to be ascertained exactly.

This is done by ascertaining an exact segmentation of the control function implemented by the MPC and of the neural network into affine mappings to subsets (segments) of the input space (i.e., typically the state space of the controlled system, also referred to as the input space or input set) in order to calculate the approximation error for training and validation of the neural network (i.e., the error between the neural network and the MPC). According to one embodiment, the segmentation is ascertained for a given input set of system states X_{safe}, which defines the operating range of interest (of the controlled system, i.e., the vehicle or, more generally, a robotic device). The set X_{safe} can be defined, for example, as the permissible (or safe) set of the underlying MPC problem. The error between the affine mappings on the segments of the MPC and the neural network is used to define a user-defined loss function that corresponds to the worst-case approximation error (between the neural network and the MPC) on X_{safe}. Minimizing this loss function until the corresponding worst-case error is contained in [symbol] _{NN} provides a safety guarantee (and, e.g., a corresponding closed-loop certificate), provided that the underlying MPC (and in particular [symbol] _{NN}) is designed in such a way that it operates safely.

According to various embodiments, a training termination criterion is thus used that is based on a loss function to be minimized such that, if it is fulfilled, the control function (or control strategy) defined by the neural network π_{NN} is guaranteed to be a sufficiently good approximation of the MPC control strategy π_{MPC}, without the need for additional verification. The method provides robust safety and stability proofs for a system according to equation (1) for an infinite time horizon, i.e., with a probability of 1. The provided training method is invariant with respect to the initial state distribution and offers robust guarantees for all possible initial states within a given polytope-shaped set X_{safe}.

For the detailed description of the training method according to one embodiment, a formulation of robust model predictive control (e.g. closed-loop control) for a system according to equation (1) is first provided, which is to be approximated by means of a neural network. Based on a measured system state x(k) at time k, the problem of robust model predictive control can be formulated as follows:

$${min}_{{\{ {u}_{i \vert k} \}}_{i = 0}^{N - 1}} {V}_{f} ( {x}_{N \vert k} ) + {\sum }_{i = 0}^{N - 1} ℓ ( {x}_{i \vert k} , {u}_{i \vert k} ) \qquad ( 6 a )$$

$$s . t . {x}_{0 \vert k} = x ( k ) , \qquad ( 6 b )$$

$${x}_{N \vert k} ∈ {𝒳}_{f} , \qquad ( 6 c )$$

$$for all i = 0 , 1 , … , N - 1 : \qquad ( 6 d )$$

$${x}_{i + 1 \vert k} = {Aw}_{i \vert k} + {Bu}_{i \vert k} , \qquad ( 6 e )$$

$${x}_{i \vert k} ∈ {𝒳}_{i} , \qquad ( 6 f )$$

$${u}_{i \vert k} ∈ {𝒰}_{i} . \qquad ( 6 g )$$

The index i

$${denotes}_{0} th {e}_{0}$$

prediction time step; N is the prediction horizon; x_{i|k} and u_{i|k} are the predicted states and inputs at prediction time step i for a given state x(k) at time step k. The input of the control loop (manipulated variable) is

$${π}_{MPC} ( x ( k ) ) = {u}_{0 \vert k}^{*}$$

(i.e., the output of the MPC), where

$${u}_{0 \vert k}^{*}$$

is the first element of the sequence of controls u_{i|k} that solves the above optimization problem (computed at time step k).

The costs l(x_{i|k}, u_{i|k}) are typically either quadratic or linear in the state or in the input. In the case of motion control, for example, they are selected in such a way that deviations from a reference trajectory (i.e., a planned trajectory), deviations from a desired speed profile, and the control effort are penalized, while driving comfort is promoted.

The robust MPC problem according to (6) uses the nominal model (6e) for prediction and compensates W and [symbol] _{NN} by means of tighter constraints. The state and input restrictions Xᵢ and Uᵢ along the prediction horizon can be selected by means of customary robustness methods for model predictive control.

The final value function V_{f} over-approximates the costs for the infinite horizon, i.e.,

$${V}_{f} ( {x}_{N \vert k} ) \geq {\sum }_{i = N}^{∞} ℓ ( {x}_{i \vert k} , {u}_{i \vert k} ) ,$$

which applies for a corresponding terminal set X_{f}. X_{f} and V_{f} can be calculated using conventional approaches for model predictive control.

Stability and the fulfillment of conditions for the controlled system according to (1) result for u(k)=u* for all consequences of disturbances that fulfill w(k)∈W, w_{NN}(k)∈ [symbol] _{NN} and all initial states x(0) that are within the permissible set of (6):

$${𝒳}_{safe} = \{ x ( k ) ∈ {ℝ}^{{n}_{x}} \vert ( 6 b ) - ( 6 g ) \} \qquad ( 7 )$$

As mentioned above, according to various embodiments for training a neural network 202 that approximates the MPC 201, instead of heuristically minimizing a standard loss by using a data set such as in (5), the fact that the MPC control function is affine on polytope-shaped sets is exploited. This means that, for each polytope P⊆X_{safe}, the MPC control function π_{MPC}: P→U can be written as

$${π}_{MPC} ( x ) = \{ \begin{matrix}{F}_{MPC}^{( 1 )} x + {G}_{MPC}^{( 1 )} , & if x ∈ {𝒫}_{MPC}^{( 1 )} , \\ ⋮ & \\ {F}_{MPC}^{( {n}_{MPC} )} x + {G}_{MPC}^{( {n}_{MPC} )} , & if x ∈ {𝒫}_{MPC}^{( {n}_{MPC} )}\end{matrix} \qquad ( 8 )$$

with n_{MPC} polytopes

$${P}_{MPC}^{( i )}$$

such that

$${⋃}_{i = 1}^{{n}_{MPC}} {P}_{MPC}^{( i )} = P$$

and with corresponding affine functions

$${F}_{MPC}^{( i )} x + {G}_{MPC}^{( i )} .$$

The polytopes are also referred to herein as MPC polytopes or MPC segments, or as first subsets (of the input space).

Techniques and tools exist for ascertaining (8) from the underlying optimization problem (6) or from a given MPC, for example in the form of library functions; see, for example, reference [1].

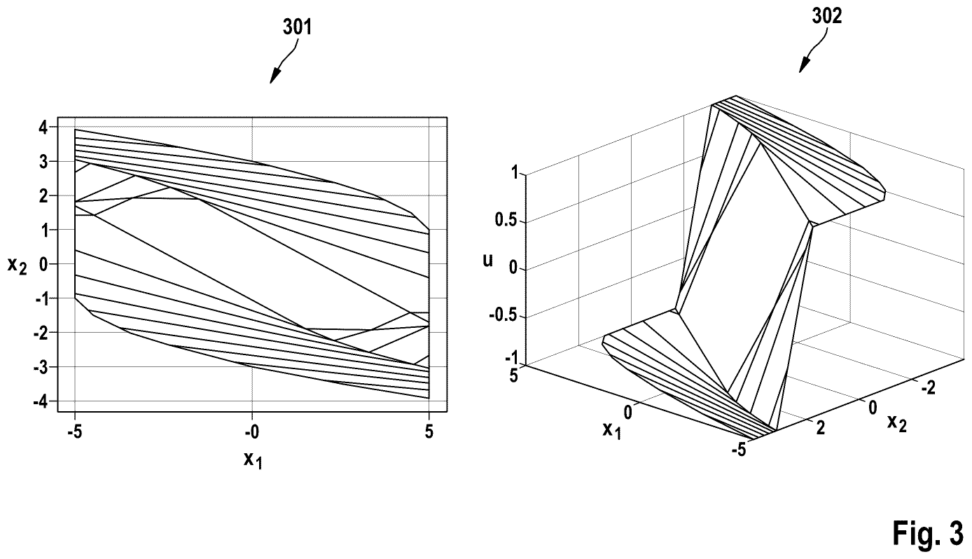

FIG. 3 illustrates the segmentation of a two-dimensional input space 301 by an MPC and the control function 302 it implements.

The function implemented by a neural network π_{NN} with ReLu activation functions can also be subdivided into affine mappings on polytope-shaped sets. According to various embodiments, this is exploited in order to construct an exact error between π_{MPC} and the approximation π_{NN} on P as follows. First, the segmentation of each MPC polytope

$${𝒫}_{MPC}^{( i )} ,$$

as performed by the neural network insofar as it operates according to various affine functions, is ascertained:

$${π}_{NN}^{( i )} ( x ; θ ) = \{ \begin{matrix}{F}_{NN}^{( 1 , i )} x + {G}_{NN}^{( 1 , i )} , & if x ∈ {𝒫}_{NN}^{( 1 , i )} , \\ ⋮ & \\ \\ {F}_{NN}^{( {n}_{NN} ( i ) , i )} x + {G}_{NN}^{( {n}_{NN} ( i ) , i )} , & if x ∈ {𝒫}_{NN}^{( {n}_{NN} ( i ) , i )}\end{matrix} \qquad ( 9 )$$

with n_{NN}(i) polytopes

$${P}_{NN}^{( j , i )} ,$$

so that

$${⋃}_{j = 1}^{{n}_{NN} ( i )} {P}_{NN}^{( j , i )} = {P}_{MPC}^{( i )} .$$

### The

$${P}_{NN}^{( j , i )}$$

are referred to as NN polytopes, NN segments or second subsets (of the MPC polytopes and thus ultimately of the input space). Techniques and tools also exist for ascertaining the partitioning of (9), for example in the form of library functions; see, for example, reference [2].

The approximation error for each NN segment is given by

$$e ( x ) = ( {F}_{MPC}^{( i )} - {F}_{NN}^{( j , i )} ) x + ( {G}_{MPC}^{( i )} - {G}_{NN}^{( j , i )} ) , \qquad ( 10 )$$

$$for x ∈ {𝒫}_{NN}^{( j , i )}$$

Error (10) offers various possibilities for constructing loss functions for training and validation. For example, loss

$${L}_{F , G} ( {π}_{MPC} , {π}_{NN} , 𝒫 ) = {\sum }_{i , j} ‖ {F}_{MPC}^{( i )} - {F}_{NN}^{( j , i )} ‖ + ‖ {G}_{MPC}^{( i )} - {G}_{NN}^{( j , i )} ‖ \qquad ( 11 )$$

allows for efficient backpropagation during training. An alternative is to minimize a limit for the largest error for each NN segment

$${\hat{e}}^{( j , i )} = {max}_{x ∈ {P}_{NN}^{( j , i )}} ‖ e ( x ) ‖ \qquad ( 12 )$$

by minimizing the approximation error at the vertices

$${v}_{NN}^{( j , i , l )}$$

of each NN polytope

$${P}_{NN}^{( j , i )} :$$

$${L}_{vert} ( {π}_{MPC} , {π}_{NN} , 𝒫 ) = {\sum }_{j , i , l} ‖ e ( {v}_{NN}^{( j , i , l )} ) ‖ . \qquad ( 13 )$$

Further modifications of the loss can comprise a weighting factor for each NN segment

$${P}_{NN}^{( j , i )}$$

in the loss function, which is based on the volume of the NN segment, or the use of a user-defined loss function that combines both loss functions (11) and (13). Training with, for example, (13) significantly outperforms the training method described above based on a data set of MPC samples according to (5) with respect to the worst-case error (14). Additionally, the segmented error (10) can be used for efficient sampling strategies of data sets of form (5) in order to supplement the loss functions (11) and/or (13) with classical loss terms, for example the mean squared error, and thus accelerate the training.

The convergence of loss functions (11) and (13) to 0 means that the worst-case approximation error

$${max}_{x ∈ 𝒫} ‖ e ( x ) ‖ = {max}_{i , j} {\hat{e}}^{( j , i )}$$

is contained in the disturbance set [symbol] _{NN}, which implies safety and stability guarantees in the closed control loop, because a w_{NN}(k)∈ [symbol] _{NN} exists, so that

$$\begin{matrix}x ( k + 1 ) = Ax ( k ) + Bu ( k ) + Ew ( k ) \\ = Ax ( k ) + B {π}_{NN} ( x ( k ) ; θ ) + Ew ( k ) \\ = Ax ( k ) + B ( {π}_{MPC} ( x ( k ) ) + {w}_{NN} ( k ) + Ew ( k )\end{matrix}$$

is consistent with the design model of the robust MPC controller according to (1). This criterion is used, for example, as a termination condition for the training method; see the following example algorithm 1. The algorithm uses the usual keywords “while,” “do” and “end.”

Algorithm 1

| | |
|---|---|
| 1 | Input: System model (e.g. according to (1)), disturbances |
| | [symbol] _{NN}, W, state and input restrictions X, U, cost 1(., .), |
| | forecast horizon N, neural network Π_{NN}(., θ) with parameters |
| | θ and ReLu activation functions (e.g. randomly initialized) |
| 2 | Calculate the components of the robust MPC problem |
| | according to (6) in order to obtain X_{f}, Xᵢ, Uᵢ, V_{f} |
| 3 | Segment the MPC control function Π_{MPC} into affine mappings |
| | on polytope-shaped sets as in (8) for P = X_{safe} |
| 4 | while {e ∈ [symbol] ⁿ^{ᵤ} \|\|e\| ≤ [symbol] \|\|e(x)\|\|} [symbol] [symbol] _{NN} do |
| 5 | Segment the function Π_{NN} implemented by the NN into affine |
| | mappings on polytope-shaped sets according to (9) |
| 6 | Backpropagation of the loss function Loss_{F,G} or Lossᵥₑᵣₜ |
| | regarding the parameters of the neural network θ |
| 7 | Update of θ, e.g. by gradient descent |
| 8 | end while |
| 9 | Output: Neural network having parameters θ that implements |
| | an NN control function Π_{NN} that approximates Π_{MPC} with robust |
| | guarantees for X_{safe} |

The algorithm starts by calculating the components of the robust MPC problem (6) in order to obtain X_{f}, Xᵢ, Uᵢ, V_{f}. The MPC control function π_{MPC} is segmented into affine mappings on polytope-shaped sets as in (8) for P=X_{safe}, e.g. using the toolbox from reference [1]. The algorithm then iterates the training method until the worst error is contained in the auxiliary disturbance set [symbol] _{NN}. During the training iterations, the function π_{NN} (which implements the neural network) is segmented into affine mappings on polytope-shaped sets according to (9), e.g. using the algorithm from reference [2]. The gradient of the loss function L_{F,G} according to (11) or Lᵥₑᵣₜ according to (13) with respect to θ is evaluated, and θ is updated, for example, by gradient descent. The algorithm outputs the specification for the trained neural network π_{NN}(i.e., the parameter θ), which approximates π_{MPC} with robust guarantees for X_{safe}.

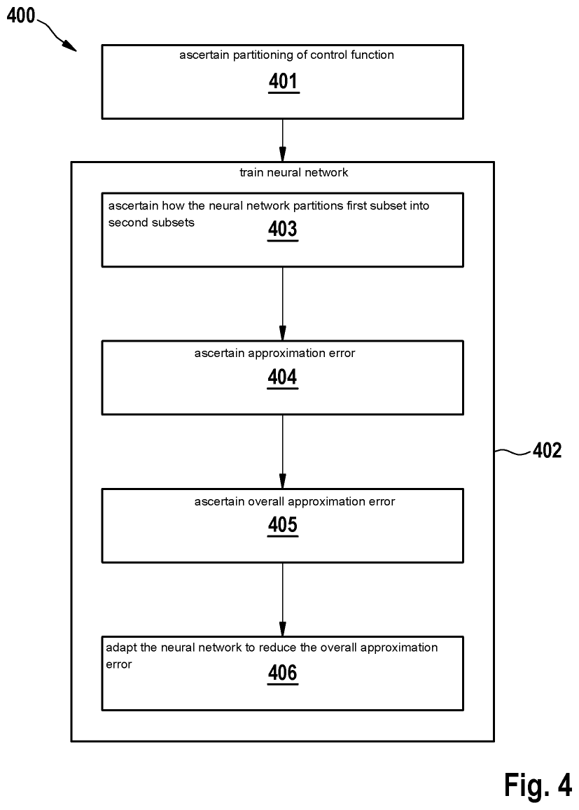

In summary, according to various embodiments, a method is provided as shown in FIG. 4.

FIG. 4 is a flowchart 400 illustrating a method for training a neural network to control a technical system (i.e., for training the neural network so that it can control the technical system) according to one embodiment.

In 401, a partitioning of a control function (which, for example, is known to comply with safety conditions or for which safety guarantees can be provided) that operates on an input space (e.g. the (permissible) set of states of the technical system (which may also include environmental states) such as speed, direction, etc.) is ascertained into a set of first affine functions, each of which operates on a particular first subset (e.g. a particular polytope) of the input space (see the segmentation (8)). In other words, the input space can be partitioned (e.g. disjointly) into the first subsets such that the control function is affine on each first subset.

In 402, the neural network (which uses ReLUs as activation functions) is trained in a plurality of iterations to approximate the control function.

This includes, for each iteration,
In 403, ascertaining, for each first subset, how the neural network partitions the first subset into second subsets (e.g. disjointly) such that it behaves like a particular second affine function on each second subset (see the segmentation (9));
In 404, ascertaining, for each of the second subsets, an approximation error between the neural network and the control function (this is easy to ascertain because only two affine functions need to be compared on the second subset; furthermore, the subsets are polytopes, which simplifies it further);
In 405, ascertaining an overall approximation error between the neural network and the control function from the approximation errors (ascertained for the second subsets); and
In 406, adapting the neural network to reduce the overall approximation error (i.e., backpropagating the overall approximation error and adjusting the neural network weights toward a decrease in the overall approximation error).

The method of FIG. 4 can be carried out by one or more computers with one or more data processing units. The term “data processing unit” may be understood as any type of entity that allows for processing of data or signals. The data or signals can be processed, for example, according to at least one (i.e., one or more than one) specific function which is carried out by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the particular functions described in more detail herein may also be understood as a data processing unit or logic circuit assembly. One or more of the method steps described in detail here can be executed (e.g. implemented) by a data processing unit by means of one or more special functions that are performed by the data processing unit.

The method is therefore in particular computer-implemented according to various embodiments.

The trained neural network can be used to control various technical systems (i.e., to generate control signals for different technical systems), in particular robotic devices. The term “robotic device” may be understood to refer to any technical system (in particular comprising a mechanical part of which the movement is controlled), such as a computer-controlled machine, a vehicle, a household appliance, a power tool, a manufacturing machine, a personal assistant, or an access control system. A control rule for the technical system is learned (by training the neural network), and the technical system is then controlled accordingly.

Sensor data from various sensors, such as video, radar, LiDAR, ultrasound, motion, thermal imaging, or information derived therefrom (by processing such as object recognition and/or classification) can be used as inputs for the neural network, in particular to provide the neural network with information about the states of the technical system to be controlled. Sensor data can be measured for different time periods.

1-10. (canceled)

11. A method for training a neural network to control a technical system, comprising the following steps:
ascertaining a partitioning of a control function operating on an input space into a set of first affine functions, each of the first affine functions operating on a respective first subset of the input space; and
training the neural network to approximate the control function in a plurality of iterations, including, for each iteration:
ascertaining, for each respective first subset, how the neural network partitions the respective first subset into second subsets such that the neural network behaves like a respective second affine function on each of the second subsets,
ascertaining, for each of the second subsets, an approximation error between the neural network and the control function,
ascertaining an overall approximation error between the neural network and the control function from the ascertained approximation errors, and
adapting the neural network to reduce the overall approximation error.

12. The method according to claim 11, wherein the approximation error for each of the second subsets is ascertained from a difference between parameters of the respective second affine function, according to which the neural network behaves on the second subset, and the respective first affine function that operates on the respective first subset to which the second subset belongs.

13. The method according to claim 11, wherein the second subsets are respective polytopes, and the approximation error for each of the second subsets is ascertained from approximation errors between the neural network and the control function at vertices of the respective polytope.

14. The method according to claim 11, wherein the control function is a control function according to model predictive control.

15. The method according to claim 11, wherein the neural network is trained until the overall approximation error is within a predetermined range.

16. The method according to claim 14, wherein the neural network is trained until the overall approximation error is contained in a disturbance set of the model predictive control.

17. A method for controlling a technical system, comprising:
training a neural network to control a technical system, including:
ascertaining a partitioning of a control function operating on an input space into a set of first affine functions, each of the first affine functions operating on a respective first subset of the input space, and
training the neural network to approximate the control function in a plurality of iterations, including, for each iteration:
ascertaining, for each respective first subset, how the neural network partitions the respective first subset into second subsets such that the neural network behaves like a respective second affine function on each of the second subsets,
ascertaining, for each of the second subsets, an approximation error between the neural network and the control function,
ascertaining an overall approximation error between the neural network and the control function from the ascertained approximation errors, and
adapting the neural network to reduce the overall approximation error; and
controlling the technical system using the neural network.

18. A data processing system configured to perform a method for training a neural network to control a technical system, the method comprising the following steps:
ascertaining a partitioning of a control function operating on an input space into a set of first affine functions, each of the first affine functions operating on a respective first subset of the input space; and
training the neural network to approximate the control function in a plurality of iterations, including, for each iteration:
ascertaining, for each respective first subset, how the neural network partitions the respective first subset into second subsets such that the neural network behaves like a respective second affine function on each of the second subsets,
ascertaining, for each of the second subsets, an approximation error between the neural network and the control function,
ascertaining an overall approximation error between the neural network and the control function from the ascertained approximation errors, and
adapting the neural network to reduce the overall approximation error.

19. A non-transitory computer-readable medium on which are stored commands for training a neural network to control a technical system, the commands, when executed by a processor, causing the processor to perform the following steps comprising:
ascertaining a partitioning of a control function operating on an input space into a set of first affine functions, each of the first affine functions operating on a respective first subset of the input space; and
training the neural network to approximate the control function in a plurality of iterations, including, for each iteration:
ascertaining, for each respective first subset, how the neural network partitions the respective first subset into second subsets such that the neural network behaves like a respective second affine function on each of the second subsets,
ascertaining, for each of the second subsets, an approximation error between the neural network and the control function,
ascertaining an overall approximation error between the neural network and the control function from the ascertained approximation errors, and
adapting the neural network to reduce the overall approximation error.
